(19) United States
(12) Patent Application Publication
(10) Pub. No.: US 2007/0140280 A1
(43) Pub. Date: Jun. 21, 2007

(54) Computer chip for connecting devices on the chip utilizing star-torus topology

(75) Inventors: Sang Woo Rhim, Seoul (KR); Eui Seok Kim, Suwon-si (KR); Beom Hak Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/452,940

(22) Filed: Jun. 15, 2006

(30) Foreign Application Priority Data
Dec. 16, 2005 (KR) 10-2005-0124586

(51) Int. Cl. H04L 12/56

(52) U.S. Cl. 370/406

(57) ABSTRACT

A computer chip including a plurality of routers, each of the plurality of the routers connected to the adjacent routers in the directions of an X axis and a Y axis; and a plurality of intellectual properties, each of the plurality of the intellectual properties connected to only one of the plurality of the routers.

### CROSS REFERENCE TO RELATED APPLICATIONS

This application claims priority from Korean Patent Application No. 2005-124586, filed on Dec. 16, 2005 in the Korean Intellectual Property Office, the disclosure of which is incorporated herein by reference.

### BACKGROUND OF THE INVENTION

1. Field of the Invention

The present invention relates to a semiconductor computer chip, and more particularly, to a system connecting devices on a computer chip by using torus topology.

2. Description of the Related Art

In the past, one system is produced by connecting a plurality of devices, each including at least one computer chip and each performing an independent function. Recently, however, a system on a chip (SOC) technology of enabling one chip to operate as an independent system by integrating a plurality of devices performing various functions on one computer chip has been developed. This is possible because of a dramatically increased number of transistors capable of being included in one chip due to semiconductor technologies being developed. In the SOC technology, several devices are integrated on one computer chip. In this case, an efficient method of connecting several devices and an efficient method of enabling the devices to exchange data is critical. Accordingly, research for enabling fast data exchange between the devices and uncomplicated connection lines connecting the devices on a computer chip is advancing.

Network configurations of devices on a computer chip shown FIGS. 1A through 3B are results of the research.

FIG. 1A is a diagram illustrating a computer chip manufactured by a method disclosed in U.S. Pat. No. 5,908,468, wherein devices on the computer chip are connected by a multiple traffic circle topology.

With respect to the method of FIG. 1A, an average hop count, an average of a number of hops through routers (120A, 120B, 120C, 120D, 120E, 120F, 120G, 120H, 122A, 122B, 122C, 122D, 122E, 122F, 122G, and 122H) required for data to be transferred from one intellectual property (IP) (110A, 110B, 110C, 110D, 110E, 110F, 110G, and 110H) to another, for each individual IP, respectively, is computed. As a number of the hops which data is transferred from one module to another module is increased, a time consumed for transferring the data also increases. Accordingly, a smaller hop count results in a smaller data delay. Therefore, a computer chip operating at high speeds may be designed. A numbers of hops from the IP 110A to other IPs 110B, 110C, 110D, 110E, 110F, 110G, and 110H is shown in FIG. 1B. Since the router 122A and the router 122B have to be passed to transfer data from the IP 110A to the IP 110B, a number of hops is two. Also, a hop count from the IP 110A to the IP 110H is two. Hop counts from the IP 110A to other IPs are shown in FIG. 1B. Since each position of each IP in the topology of FIG. 1A is respectively equivalent, a case of computing hop counts from other IPs 110B, 110C, 110D, 110E, 110F, 110G, and 110H to other IPs is identical with the hop count computation from the IP 110A. Accordingly, the average hop count from one IP to another IP in the topology in FIG. 1A becomes 3.29 as shown in FIG. 1B.

Next, an efficiency of channel utilization with respect to the topology of FIG. 1A is computed. For this, Number of router ports used per IP is computed. Namely, a value of a result of computing a number of all ports of all routers with respect to one topology and dividing the computed number by the number of the IPs is used. Since the value is the same as a number of links per unit, the value is called as an L/U ratio, in which L indicates the number of links and U indicates units. The L/U ratio may be computed by Equation 1 as follows.

L/U ratio=number of router ports/number of IPs Equation 1

In Equation 1, since two ports form one link, a result of Equation 1 is divided by two, thereby computing the number of links per IP. Accordingly, when an L/U ratio is high, a number of links used per IP is large. When the number of links used per IP is large, the number of lines connecting modules in an SOC is large, thereby complicating wiring. Accordingly, since lowering the L/U ratio results in a smaller number of links in a computer chip, complexity in design is reduced and reduces a size of the chip.

There are eight IPs in FIG. 1A. A total number of ports used in connecting the IPs is computed. In FIG. 1A, connections between routers are unidirectional and connections between routers and IPs are bidirectional. In an outer circle, there is one input port and one output port for connecting one router to another router, respectively, therefore there are 8*2=16 ports. In an inner circle, there is one input port and one output port for connecting one router to another router, respectively, therefore there are 8*2=16 ports. Also, since a total number of connections between routers and IPs is 16 and the connections are bidirectional, there are 16*2=32 ports. Accordingly, an L/U ratio of the topology in FIG. 1A is computed as ((8*2)+(8*2)+(16*2))/8=8.

FIG. 2A is a diagram illustrating a computer chip made by a method disclosed in U.S. Pat. No. 5,974,478, wherein devices on the computer chip are connected by a mesh of rings topology.

With respect to the method of FIG. 2A, an average of a number of hops through routers (240A, 240B, 240C, 240D, 240E, 246F, 240G, 240H, 240I, 240J, 240K, and 240L) required for data to be transferred from one IP (210A, 210B, 210D, 210E, 210F, 210G, 210H, and 210I) to another IP, for each individual IP, respectively, is computed. In FIG. 2A, reference numerals are IPs, are routers. In FIG. 2A, connections between routers are unidirectional, and connections between a router and an IP are bidirectional. A numbers of hops from the IP 210A to other IPs 210B, 210D, 210E, 210F, 210G, 210H, and 210I is shown in FIG. 2B. Since the router 240A and the router 240D have to be passed to transfer data from the IP 210A to the IP 210E, a number of hops is two. Hop counts from the IP 210A to other IPs are shown in FIG. 2B. However, unlike the topology of FIG. 1A, positions of each IP are not respectively equivalent in FIG. 2A. Positions of IP 210G and IP 210I are equivalent with IP 210A. Positions of the IP 210B, 210D, 210F, and IP 210H are equivalent. There is no IP whose position is equivalent to the IP 210E. Accordingly, the average hop count with respect to the topology of FIG. 2A is computed as 4.28 as shown FIG. 2B, via a process in which the average hop count with respect to each IP are totally added and divided by seven that is a number of total IPs. For example, in FIG. 2B, when an average hop count with respect to the IP 210A is (2+3+(4*4)+5)/7 and average hop counts of the IP 210G and the IP 210I are equivalent with the average hop count of the IP 210A, the average hop count of the IP 210A is multiplied by 3.

Next, to measure an efficiency of channel utilization with respect to the topology of FIG. 2A, an L/U ratio is computed. In FIG. 2A, there are a total of eight IPs. Number of total ports used in connecting the IPs is computed. In FIG. 2A, connections between routers are unidirectional and connections between a router and an IP are bidirectional. In an outer circle, there are eight routers. Also, since input/output ports for connecting with other routers are three per one router, there are 8*3=24 ports in the outer circle. In an inner mesh, there are four routers. Since the router has four input/output ports for connecting with other routers, there are 4*4=16 ports between routers in the inner mesh. Also, since there are eight bidirectional connections between the routers and the IPs, there are 8*2=16 ports. Accordingly, the L/U ratio of the topology in FIG. 2A is computed as ((8*3)+(4*4)+(8*2))/8=7.

FIG. 3A is a diagram illustrating a computer chip made by a method disclosed in U.S. Pat. No. 6,266,797. According to a conventional technology of FIG. 3A, devices on the computer chip are connected by a multiple ring topology.

With respect to the method of FIG. 3A, an average hop count, an average of a number of hops through routers (320A, 320B, 320C, 320D, 320E, 320F, 320G, 320H, 325A, 325B, 325C, and 325D) required for data to be transferred from one IP (310A, 310B, 310C, 310D, 310E, 310F, 310G, and 310H) to another IP, for each individual IP, respectively, is computed. In FIG. 3A, connections between routers and connections between routers and IPs are bidirectional. Numbers of hops from the IP 310A to other IPs 310B, 310C, 310D, 310E, 310F, 310G, and 310H are shown in FIG. 3B. Since the router 320A and the router 320B have to be passed to transfer data from the IP 310A to the IP 310B, a number of hops is two. Hop counts from the IP 310A to other IPs are shown in FIG. 3B. Positions of the IP 310D, the IP 310E, and the IP 310H are equivalent to a position of the IP 310A. However, a position of the IP 310B is not equivalent to the position of the IP 310A. Hop counts from the IP 310B to other IPs 310A, 310C, 310D, 310E, 310F, 310G, and 310H are shown in FIG. 3B. The IPs 310C, 310D, 310E, 310F, and 310G are equivalent to the IP 310B in position. Accordingly, the average hop count with respect to the topology of FIG. 3A is computed as 3.58 as shown FIG. 3B.

Next, to measure an efficiency of channel utilization with respect to the topology of FIG. 3A, an L/U ratio is computed. In FIG. 3A, there are a total of eight IPs. A total number of ports used in connecting the IPs is computed. In FIG. 3A, both connections between routers and connections between routers and IPs are bidirectional. The routers 320A, 325A, 320E, 320D, 325D, and 320H disposed in first and fourth rows have three input ports and three output ports, respectively, because of being bidirectional. In FIG. 3A, though the IP 310A is shown as being attached to the router 320A, actually, the IP 310A is connected to the router 320A by bidirectional link. Accordingly, a total number of ports of the routers disposed in the first and fourth rows is computed as “number of routers (6) * number of ports per router (3*2)=36”. A total number of ports of the routers 320B, 325B, 320F, 320C, 325C, and 320G disposed in second and third rows is computed as “6*4*2=48.” Accordingly, the L/U ratio of the topology of FIG. 3A is computed as ((6*6)+(8*6))/8=10.5.

In spite of the described conventional technologies, a computer chip capable of performing data even faster exchange between devices and having simpler connection lines connecting the devices on the computer chip at the same time is required.

### SUMMARY OF THE INVENTION

Illustrative, non-limiting embodiments of the present invention overcome the above disadvantages and other disadvantages not described above. Also, the present invention is not required to overcome the disadvantages described above, and an illustrative, non- limiting embodiment of the present invention may not overcome any of the problems described above.

The present invention provides a computer chip capable of quickly transferring data and operating at high speeds by reducing a number of hops through routers through which the data is transferred from one module to another module on the computer chip.

The present invention also provides a computer chip in which modules on the computer chip are disposed with a small L/U ratio to reduce a number of lines connecting the modules on the computer chip, thereby reducing complexity in designing the computer chip and reducing a size of the computer chip.

The present invention also provides a method of performing efficient data communication on a star torus topology or star mesh topology on the computer chip, and a packet format.

The present invention also provides a computer chip having high extensibility, in which modules may be easily added, thereby being applicable to designing a computer chip requiring a large number of IPs.

According to an aspect of the present invention, there is provided a computer chip including: a plurality of routers comprised on the computer chip, each of the plurality of the routers connected to the adjacent routers in the directions of X axis and Y axis; and a plurality of intellectual properties comprised on the computer chip, each of the plurality of the intellectual properties connected to at least one of the plurality of the routers.

The router includes: a plurality of input/output ports; an X flow controller controlling a data flow between the router and a router connected to the router in the direction of the X axis; an X arbiter arbitrating communication between the router and a router connected to the router in the direction of the X axis; a Y flow controller controlling a data flow between the router and a router connected to the router in the direction of the Y axis; a Y arbiter arbitrating communication between the router and a router connected to the router in the direction of the Y axis; an intellectual property flow controller controlling a data flow between the router and an intellectual property of the plurality of intellectual properties connected to the router; an intellectual property arbiter arbitrating communication between the router and the intellectual property connected to the router; and a switch switching the plurality of the input/output ports.

Each of the plurality of the routers is bidirectionally connected to each of the routers in the direction of X axis and Y axis.

Each of the plurality of the routers is connected by a circular topology with respect to the X axis and the Y axis,

According to another aspect of the present invention, there is provided a computer chip including: a plurality of routers comprised on the computer chip; a plurality of communication paths connecting the plurality of the routers, wherein the plurality of the communication paths is configured in a torus topology; and a plurality of intellectual properties comprised on the computer chip, wherein each of the plurality of the intellectual properties is connected to one of the plurality of the routers.[match to claim 15]

### BRIEF DESCRIPTION OF THE DRAWINGS

The above and/or other aspects of the present invention will become apparent and more readily appreciated from the following detailed description of exemplary embodiments, taken in conjunction with the accompanying drawings of which:

FIG. 1A is a diagram illustrating a computer chip on which devices are connected in a multiple traffic circle topology according to a conventional technology;

FIG. 1B shows an example of calculation of an average hop count of FIG. 1A;

FIG. 2A is a diagram illustrating a computer chip on which devices are connected in a mesh of rings topology according to a conventional technology;

FIG. 2B shows an example of calculation of an average hop count of FIG. 2A;

FIG. 3A is a diagram illustrating a computer chip on which devices are connected in a multiple ring topology according to a conventional technology;

FIG. 3B shows an example of calculation of an average hop count of FIG. 3A;

FIG. 4 is a diagram illustrating a computer chip on which devices are connected according to an exemplary embodiment of the present invention;

FIG. 5 is a block diagram illustrating a router according to an exemplary embodiment of the present invention;

FIG. 6 is a block diagram illustrating the router of FIG. 5 in detail;

FIG. 7 is a diagram illustrating a packet exchanged between the devices on the computer chip according to an exemplary embodiment of the present invention;

FIG. 8 is a diagram illustrating a computer chip on which devices are connected according to a star mesh topology according to an exemplary embodiment of the present invention; and

FIGS. 9A and 9B are diagrams illustrating a calculation of an average hop count of the computer chip according to an exemplary embodiment of the present invention.

### DETAILED DESCRIPTION OF EXEMPLARY EMBODIMENTS OF THE INVENTION

Reference will now be made in detail to the exemplary embodiments of the present invention, examples of which are illustrated in the accompanying drawings, wherein like reference numerals refer to the like elements throughout. The exemplary embodiments are described below to explain the present invention by referring to the figures.

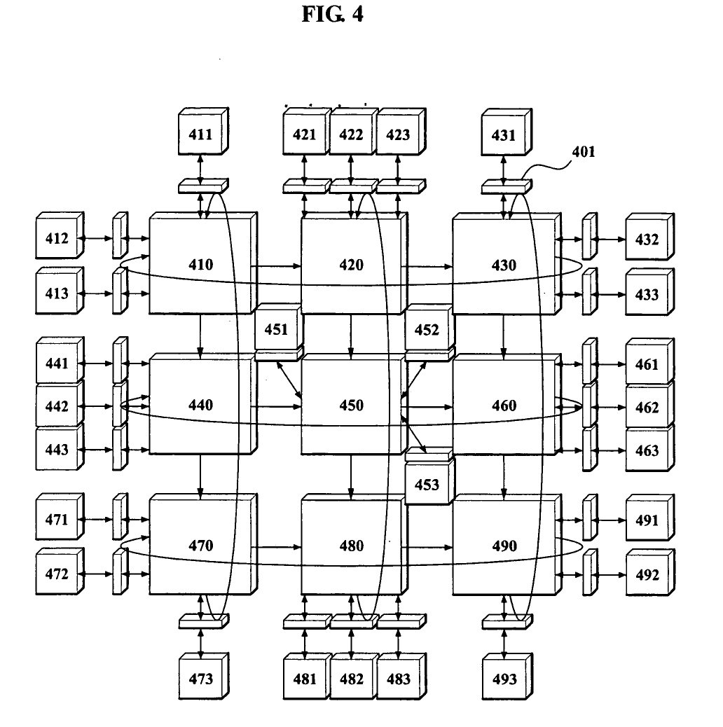

FIG. 4 is a diagram illustrating a computer chip on which devices are connected according to an exemplary embodiment of the present invention.

The computer chip includes a plurality of routers 410, 420, 430, 440, 450, 460, 470, 480, and 490 and a plurality of intellectual properties (IPs) 411, 412, 413, 421, 422, 423, 431, 432, 433, 441, 442, 443, 451, 452, 453, 461, 462, 463, 471, 472, 473, 481, 482, 483, 491, 492, and 493, formed thereon. In FIG. 4, although the routers are shown to be larger than the IPs, the IPs are typically larger than the router by approximately one hundred times.

The IP is a module performing a certain function on a computer chip, such as a processor IP, a graphic controller IP, and a memory IP. The IPs may be designed as independent IPs to be sold to an SOC manufacturing company. The router is a module for routing data from a source IP to a destination IP.

Each of the plurality of the IPs is connected to only one of the plurality of the routers. For example, in FIG. 4, the IP 411 is connected to the router 410, and the IP 421 is connected to the router 420. In FIG. 4, each of the plurality of the IPs is connected to one of the plurality of the routers. As described above, since each of the IPs is connected to only one router, routing becomes simplified and a configuration of elements forming the router becomes smaller. The communication path connecting the routers indicates a path connecting the routers, such as a communication path connecting the router 410 with the router 420.

Also, according to an exemplary embodiment of the present invention, each of the plurality of the IPs is bidirectionally connected to one of the plurality of the routers. Since the IP requires input/output ports, bidirectional connection with the router is required. In this case, when a router to which the input port of the IP is connected and a router to which the output port of the IP is connected are constructed as the same router, wiring on the computer chip becomes simplified and routing also becomes simplified, thereby reducing a size of configuration of the elements forming the router.

Each of the plurality of the routers is connected to adjacent routers in the direction of an X axis and a Y axis. For example, in FIG. 4, the router 410 is connected to the router 420 in the direction of the X axis and connected to the router 440 in the direction of the Y axis. The router 450 is connected to the router 440 and the router 460 in the direction of the X axis and connected to the router 420 and the router 480 in the direction of the Y axis. Accordingly, according to the present exemplary embodiment, the router is connected to no more than two routers in the direction of the X axis and connected to at most two routers in the direction of the Y axis. Although the directions of the X axis and the Y axis are used for distinguishing two different directions in the exemplary embodiments of the present invention, other axes may be used and the directions of the X axis and the Y axis do not need to have certain degrees of an angle. Also, the routers connected in the direction of the X axis or the Y axis do not need to be disposed in one line on the computer chip. For example, the router 420 may be disposed on a position higher than a position in FIG. 4, or the router 440 may be disposed on a position on the left and lower than a position in FIG. 4.

According to an exemplary embodiment of the present invention, the plurality of the routers is connected in a circular topology, with respect to each of the directions of the X axis and the Y axis. Particularly, when the plurality of the routers is connected in a unidirectional circular topology, with respect to each of the directions of the X axis and the Y axis, the routers form a torus topology as shown in FIG. 4. In FIG. 4, as the router 410 is connected to the router 420, the router 420 is connected to the router 430, and the router 430 is connected to the router 410, the routers are connected in the shape of a unidirectional circle in the direction of the X axis. It is the same with respect to the direction of the Y axis.

A case in which a plurality of routers form a torus topology and each of a plurality of IPs is connected to one of the plurality of routers is designated as a star torus topology in the present invention. An example of the star torus topology is shown in FIG. 4. Namely, a computer chip formed in the star torus topology includes a plurality of routers, a plurality of communication paths connecting the plurality of routers and formed of a torus topology, and a plurality of IPs formed on the computer chip, each of the plurality of IPs connected to one of the plurality of routers.

According to an exemplary embodiment of the present invention, a router may route data from a source IP to a destination IP by a wormhole routing or an X-Y routing. However, in the case of the torus topology, when more than 2*2 routers are included, for example, including 3*3 routers shown in FIG. 4, or more than 2*3 or 3*2, a dead lock may occur in routing. Accordingly, to solve this, the router according to the present exemplary embodiment may employ a virtual channel. The virtual channel is provided for routing at high speeds, in which a virtual output buffer is included in an input buffer. Also, by using current achievements in research, though the virtual channel is used, a router may be constructed to be relatively simple.

Also, according to another exemplary embodiment of the present invention, each of a plurality of routers is connected in a bidirectional circular topology instead of a unidirectional circular topology, with respect to each of the directions of an X axis and a Y axis. According to the present exemplary embodiment, since the number of communication paths is increased to be more than the unidirectional circular topology, a dead lock may occur. However, in a torus structure of more than 3*3 routers, since the virtual channel is used, a dead lock may be prevented, thereby employing a simple routing method such as the X-Y routing. Accordingly, according to the present exemplary embodiment, the construction of the router becomes simplified.

Also, according to an exemplary embodiment of the present invention, a network interface element is connected between a router and an IP. Namely, the router is connected to the IP via the network interface element. In FIG. 4, a network interface element 401 is located between the router 430 and the IP 431. In this case, the network interface element 401 performs protocol conversion between the router 430 and the IP 431. In the case of the IP, an IP designed by independent companies may be used. In this case, since the IP has an interface specification according to own specification, an element for converting the interface specification of the IP into another interface specification of the router. In the case of designing IPs and routers to meet one interface specification, the network interface element is not required. However, since each company has its own expertise, buying IPs of another company and respectively connecting the IPs may be more profitable or desirable than designing each various IP such as a processor IP, a memory IP, and a graphic controller IP by one company in general. Accordingly, in the case of using IPs of another company, the network interface element is required. For example, when IPs using AMBA 3.0 bus use an AXI protocol, IPs using SONICS bus use an OCP protocol, and routers use a newly designed protocol such as SAIT On-Chip Interconnect (OCI), general IPs may be used by including the network interface element.

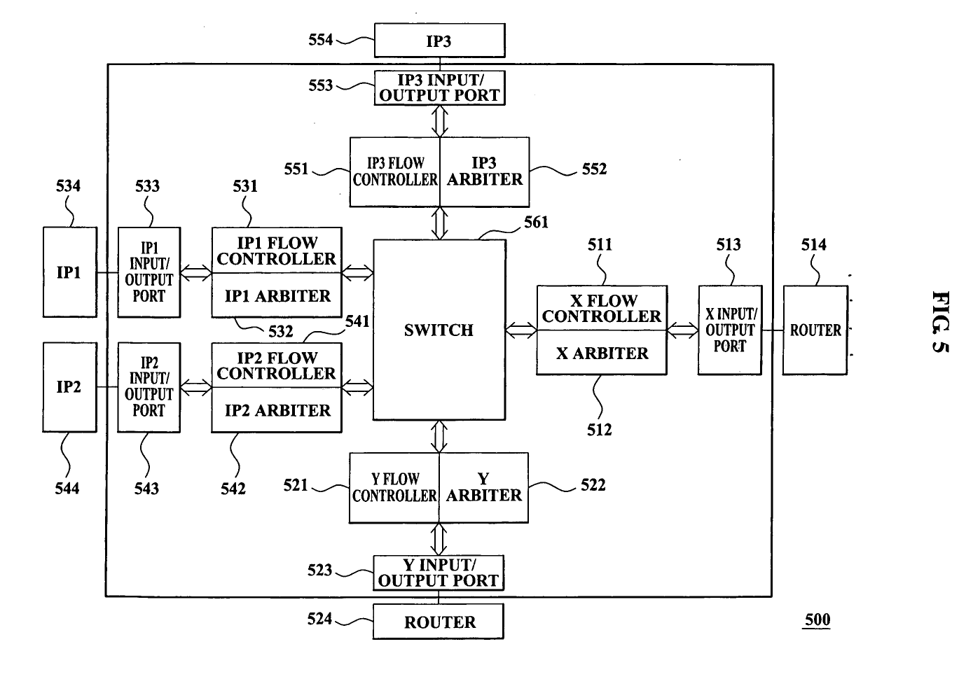

FIG. 5 is a block diagram illustrating a router 500 according to an exemplary embodiment of the present invention.

A router routes data from a source IP to a destination IP. The router 500 includes a plurality of input/output ports 513, 523, 533, 543, and 553, an X flow controller 511, an X arbiter 512, a Y flow controller 521, a Y arbiter 522, IP flow controllers 531, 541, and 551, IP arbiters 532, 542, and 552, and a switch 561.

The X flow controller 511 controls a data flow between the router 500 and a router 514 connected to the router 500 in the direction of an X axis. For example, when data is transferred between the router 500 and the router 514, if a buffer of a receiving router is full, the X flow controller 511 controls transmission of data to wait. The Y flow controller 521 controls a data flow between the router 500 and a router 524 connected to the router 500 in the direction of a Y axis. The IP flow controllers 531, 541, and 551 control the data flow between the router 500 and IPs 534, 544, and 554 connected to the router 500.

The X arbiter 512 arbitrates communication between the router 500 and the router 514 connected to the router 500 in the direction of the X axis, the Y arbiter 522 arbitrates communication between the router 500 and the router 524 connected to the router 500 in the direction of the Y axis, and IP arbiters 532, 542, and 552 arbitrate communication between the router 500 and the IPs 534, 544, and 554. For example, when data input from the IP1 534 and data input from the IP2 544 request to be transferred at the same time, the IP1 arbiter 532, the IP2 arbiter 542, and the X arbiter 512 communicate with each other and arbitrate this situation to be solved.

The switch 561 switches the plurality of input/output ports and adjusts a data input/output path. For the switch 561, a crossbar switch may be used. The input/output ports 513, 523, 533, 543, and 553 are ports for inputting and outputting data between the router 500 and the routers 514 and 524 or the IPs 534, 544, and 554.

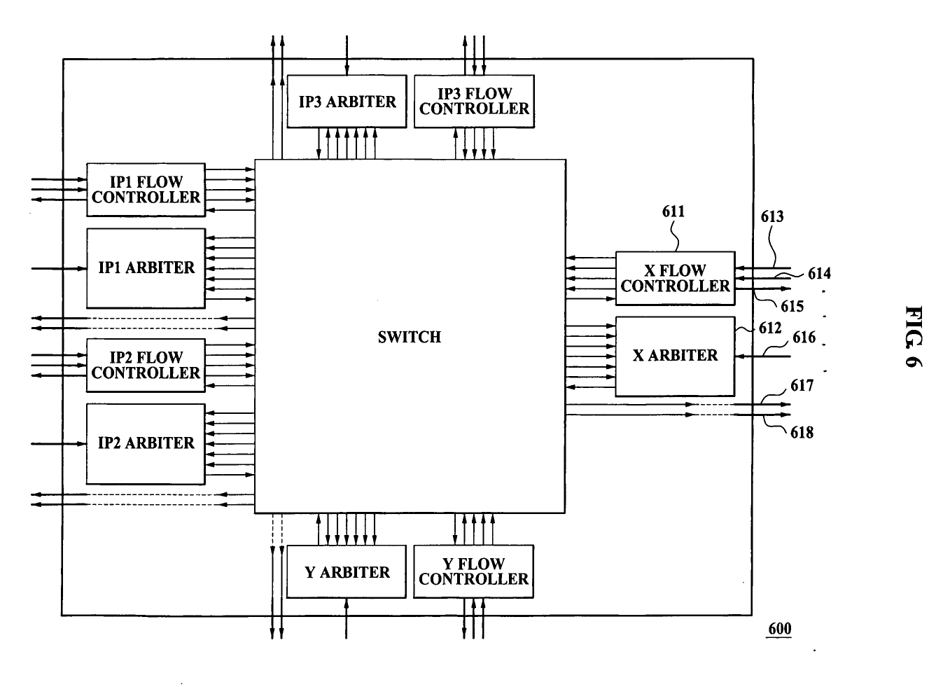

FIG. 6 is a block diagram illustrating the router of FIG. 5 in detail. Data communication between a router 600 and a router connected to the router 600 by using an X arbiter 612 will be described with reference to FIG. 6.

A case in which the router 600 receives data from the router connected to the router 600 in the direction of the X axis (hereinafter, referred to as a next router) will be described. When an input buffer of an X flow controller 611 is available, the X flow controller 611 transmits a signal indicating that the input buffer is available at the present time to the next router via a buf_avail line 615. If data required to be sent to the router exists, the next router polls the buf_avail line 615 transmitted from the X flow controller 611. If a signal transmitted via the buf_avail line 615 is “buffer full,” the next router does not transmit data and wait. Therefore, the X flow controller 611 controls a data communication flow in the direction of the X axis. When a signal of the buf-avail line 615 is “buffer available” as a result of polling the buf avail line 615, the next router transmits a data signal to the X flow controller 611 of the router 600 via a data line 613. The data signal may be transmitted in a serial or a parallel communication. In the case of the parallel communication, the data line 613 has a communication line corresponding to a size of data that has to be transmitted at the same time. For example, in the case of transmitting 32 bits at one time, the data line 613 has 32 communication lines. Together with this, the next router transmits a valid signal to the X flow controller 611 via a valid line 614. When a value of a signal input via the valid line 614 is “valid,” the X flow controller 611 stores a packet input via the data line 613 in the input buffer thereof.

The packet is then transferred to a switch. The switch analyzes a destination address of the packet and determines a port to which the packet is to be transferred. The switch then transmits the packet to the determined port.

A case in which the router 600 transmits data to the next router connected to the router 600 in the direction of X axis will be described. When an input buffer of the next router is available, a signal of a buf_avail line 616 from the next router becomes “buffer available.” Then, the switch transmits data to be transmitted to the next router to the next router via a data line 617. Also, the switch transmits a valid signal to the next router via a valid line 618.

In FIG. 6, with respect to each of the directions of the X axis and the Y axis, an IP1, an IP2, and an IP3, in total, 30 ports are required, for example, one input data port, one output data port, one input buf_avail port, one output buf_avail port, one port for valid information of input data, and one port for valid information of output data.

Hitherto, though the data communication between the router 600 and the next router connected to the router 600 in the direction of X axis has been described, data communication between the router 600 and a router connected thereto in the direction of the Y axis and IPs may be operated by the same method.

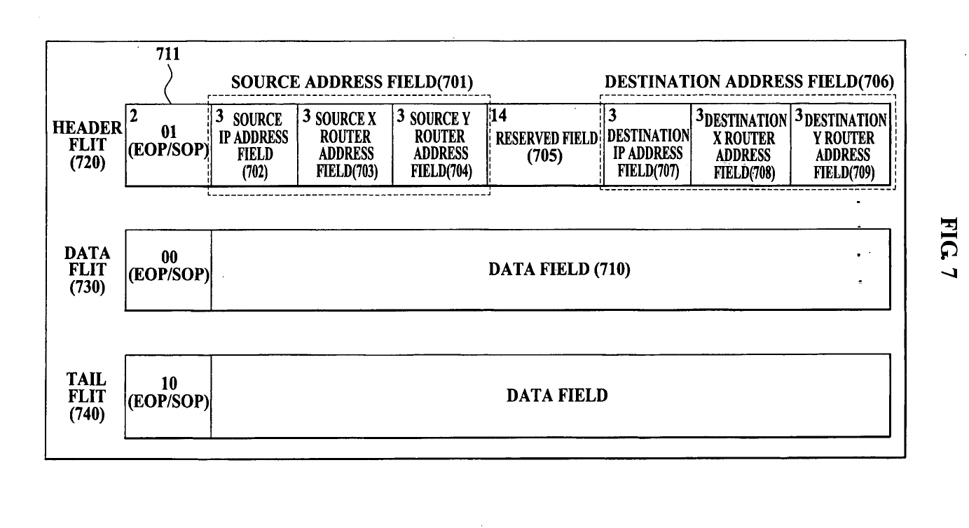

FIG. 7 is a diagram illustrating an example of a packet exchanged between the devices on the computer chip, according to an exemplary embodiment of the present invention.

According to an exemplary embodiment of the present invention, data communicated between routers and IPs on a computer chip is transferred as a packet. An example of a packet is shown in FIG. 7, and the packet of FIG. 7 is formed of a header flit 720, a data flit 730, and a tail flit 740.

The header flit 720 includes a header. An EOP/SOP field displays information on whether a present flit is a start of a packet, an end of a packet, or an intermediate of a packet. In a current example of the header flit 720, the EOP/SOP field has a value of “01” indicating the start of a packet. Since a header is disposed at the start of a packet, if the EOP/SOP field has a value of “01,” a flit is a header flit.

The header flit 720 includes a source address field 701, a reserved field 705, and a destination address field 706. In the source address field 701, an address of an IP transmitting this packet is recorded. The source address field 701 includes a source IP address field 702, a source X router address field 703, and a source Y router address field 704. The destination address field 706 includes a destination IP address field 707, a destination X router address field 708, and a destination Y router address field 709.

Addresses of IPs, input to the IP address fields 702 and 707, may be uniquely identifiable, from addresses of IPs connected to the router to which the IP is connected. Also, an address of a router includes an X router address and Y router address. A router on the computer chip according to the present exemplary embodiment may be uniquely identified by the X router address and Y router address, from the computer chip.

For example, an address of the router 420 of FIG. 4 may be (1, 0). In this case, an X router address of the router 420 is “1” and a Y router address of the router 420 is “0.” Also, an address of the router 410 is (0, 0), an address of the router 430 is (2, 0), an address of the router 440 is (0, 1), an address of the router 450 is (1, 1), an address of the router 460 is (2, 1), an address of the router 470 is (0, 2), an address of the router 480 is (1, 2), and an address of the router 490 is (2, 2). Accordingly, in the case of FIG. 4, with respect to an X router address field and a Y router address field, two bits are sufficient, respectively.

In FIG. 4, an address of the IP 411 is uniquely identified from the IPs 411, 412, and 413 connected to the router 410 to which the IP 411 is connected. For example, with respect to each of the IPs 411, 412, and 413, “00”, “01”, and “10” in binary, are allocated. Also, addressees of the IPs 421, 422, and 423 connected to the router 420 are “00”, “01”, and “10”, respectively. The IP address has to be identified from the IPs connected to the router to which the IP is connected. Accordingly, in order to exclusively identify one IP from the computer chip, the IP address and router address are all required. For example, the IP 423 may be exclusively identified by an address of (10, 00, 01). In this case, “10” is an address of the IP 423 and (00, 01) is an address of the router 420 to which the IP 423 is connected.

Accordingly, the address of the source IP, input to the source IP address field 702, can be uniquely identified from the IPs connected to the router to which the source IP is connected. The address of the destination IP, input to the destination IP address field 707, can be uniquely identified from the IPs connected to the router to which the destination IP is connected.

The reserved field 705 may be used for recording other information in a packet in the future.

The data flit 730 is formed of an EOP/SOP field and a data field 710. In the data field 710, data is recorded. When a plurality of data flits is required due to a size of data, a plurality of continuous data flits are transmitted and finally, the tail flit 740 is transmitted. The tail flit 740 is disposed at the end of a packet and indicates that a present flit is a tail flit by a value of “10” in the EOP/SOP field. Any final data is included in the data field of the tail flit 740.

A switch included in a router analyzes the destination address field 706 and transfers the packet including the header flit 720, data flit 730, and the tail flit 740 to a suitable output port.

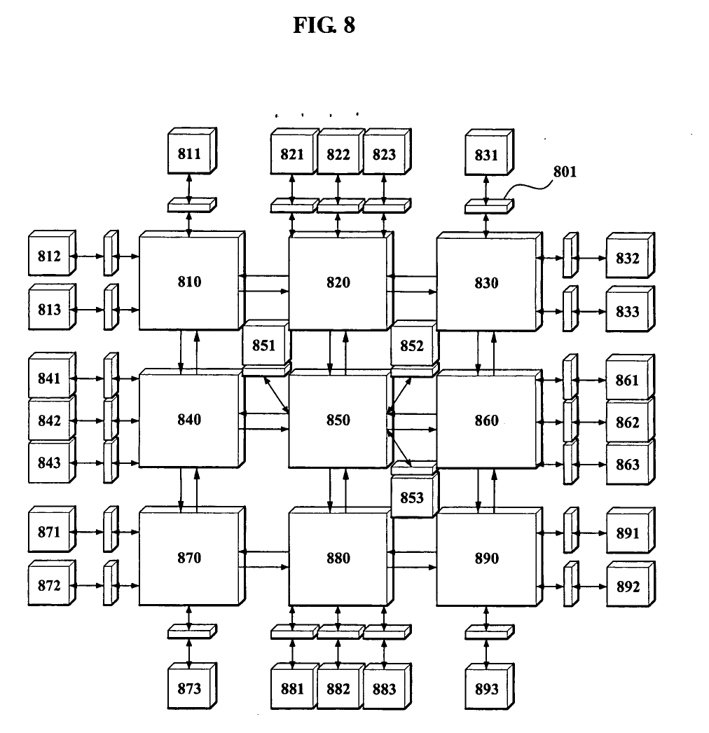

FIG. 8 is a diagram illustrating a computer chip on which devices are connected in a star mesh topology according to an exemplary embodiment of the present invention.

In FIG. 8, reference numerals 811, 812, 813, 821, 822, 823, 831, 832, 833, 841, 842, 843, 851, 852, 853, 861, 862, 863, 871, 872, 873, 881, 882, 883, 891, 892, and 893 are IPs, and 810, 820, 830, 840, 850, 860, 870, 880, and 890 are routers. Each of a plurality of the IPs is connected to only one of a plurality of routers. For example, in FIG. 8, the IP 811 is connected to the router 810, and the IP 821 is connected to the router 820. Each of the plurality of the IPs may be bidirectionally connected to one of the plurality of the routers.

Each of the plurality of the routers is connected to next routers in the directions of an X axis and a Y axis. As shown in FIG. 8, each of the plurality of routers is bidirectionally connected to the next routers in the directions of the X axis and the Y axis. Referring to FIG. 8, the router 840 is bidirectionally connected to the router 850 in the direction of the X axis and bidirectionally connected to the routers 810 and 870 in the direction of the Y axis. In FIG. 8, there is no circular connection as shown in FIG. 4. As described above, a case in which the routers are bidirectionally connected to the next router in the directions of the X axis and the Y axis and each of the IPs is connected to one of a plurality of routers is designated as a star mesh topology in the present invention. The case shown in FIG. 8 is an example of the star mesh topology according to the present invention.

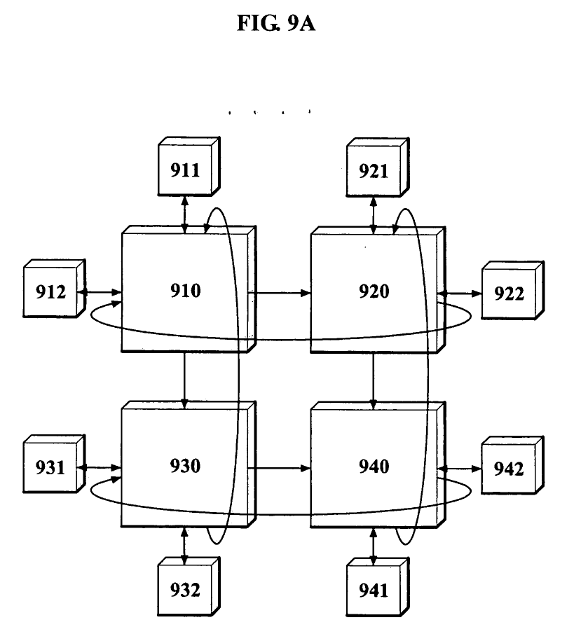

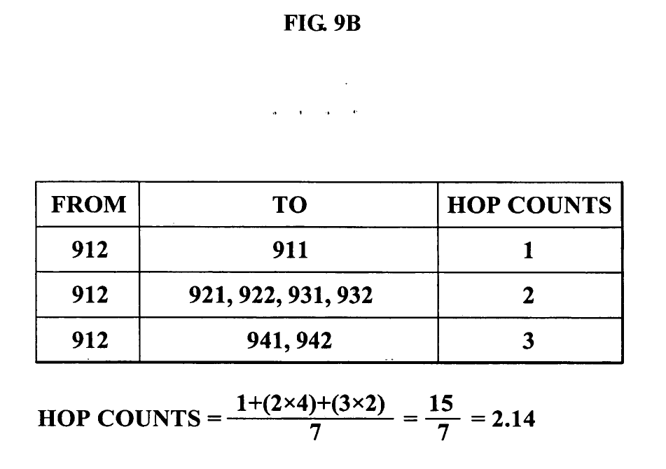

FIGS. 9A and 9B are diagrams illustrating an average hop count in the computer chip according to an exemplary embodiment of the present invention.

In FIG. 9A, since each of routers 910, 920, 930, and 940 is connected in each directions of an X axis and a Y axis in a unidirectional circular topology and each of IPs 911, 912, 921, 922, 931, 932, 941, and 942 is connected to one of the routers, the topology shown in FIG. 9A is an example of the star torus topology according to an exemplary embodiment of the present invention.

Also, since the routers 910, 920, 930, and 940 are actually bidirectionally connected to next routers in the directions of the X axis and the Y axis and each of the IPs 911, 912, 921, 922, 931, 932, 941, and 942 is connected to one of the routers, the topology shown in FIG. 9A is an example of the star mesh topology according to the present invention. Namely, in the case of disposing 2*2 routers, the star torus topology and star mesh topology according to the present invention may have the same topology.

With respect to the method of FIG. 9A, an average hop count, an average of a number of hops through routers required for data to be transferred from one IP to another, for each individual IP, respectively, is computed. In FIG. 9A, reference numerals 911, 912, 921, 922, 931, 932, 941, and 942 are the IPs and 910, 920, 930, and 940 are the routers. A numbers of hops from the IP 912 to other IPs 911, 921, 922, 931, 932, 941, and 942 are shown in FIG. 9B. Since the router 910 is passed through in order to transfer data from the IP 912 to the IP 911, a hop count is one. Since the router 910 and the router 920 are passed through in order to transfer data from the IP 912 to the IP 921, a hop count is two. Also, hop counts from the IP 912 to other IPs are shown in FIG. 9B. The IPs 922, 932, and 942 are equivalent to the IP 912 in position. Accordingly, the average hop count with respect to the topology of FIG. 9A is computed as 2.14 as shown in FIG. 9B.

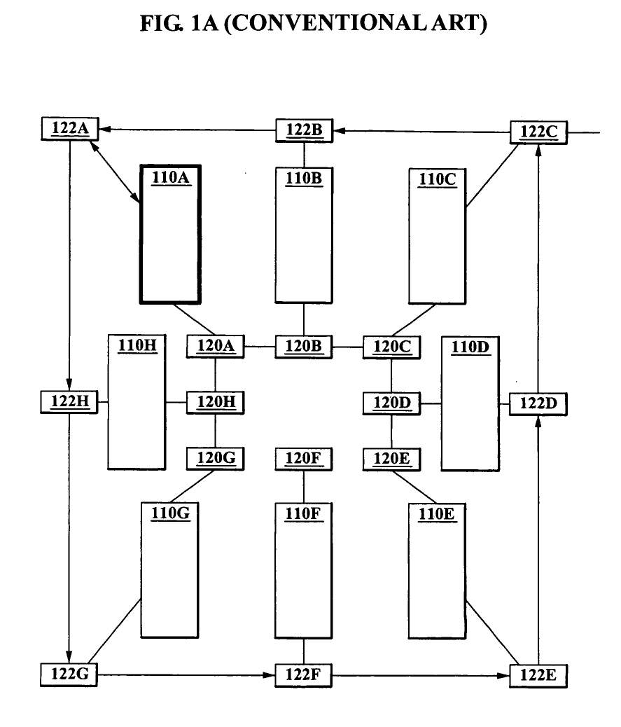

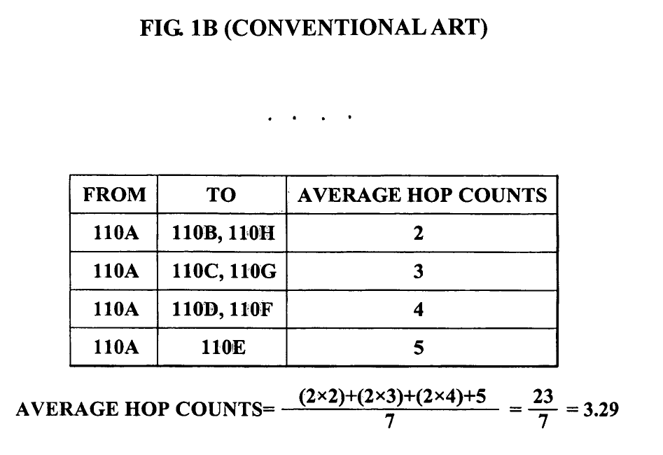

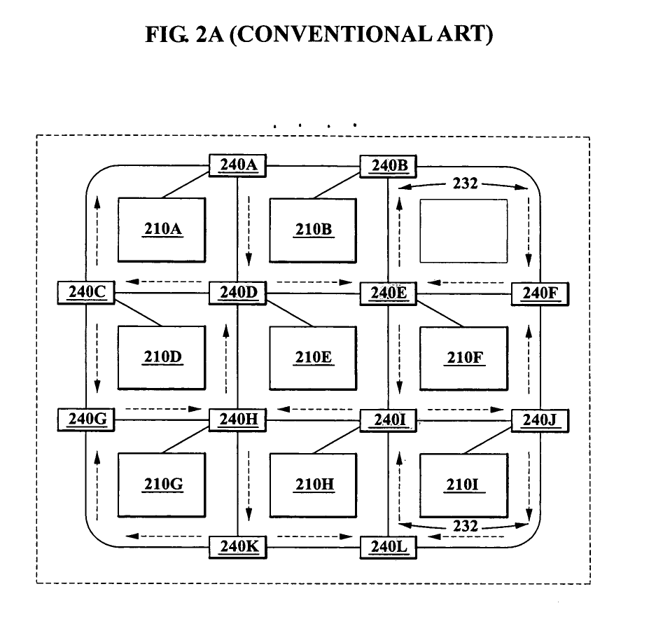

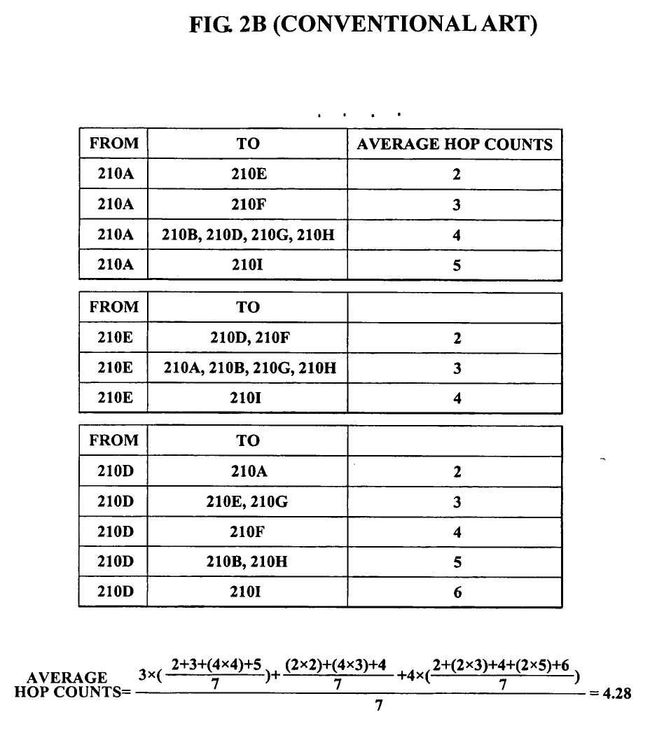

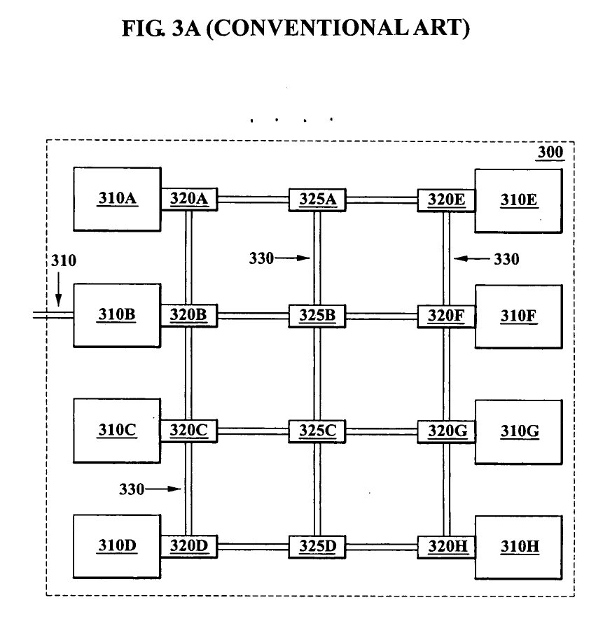

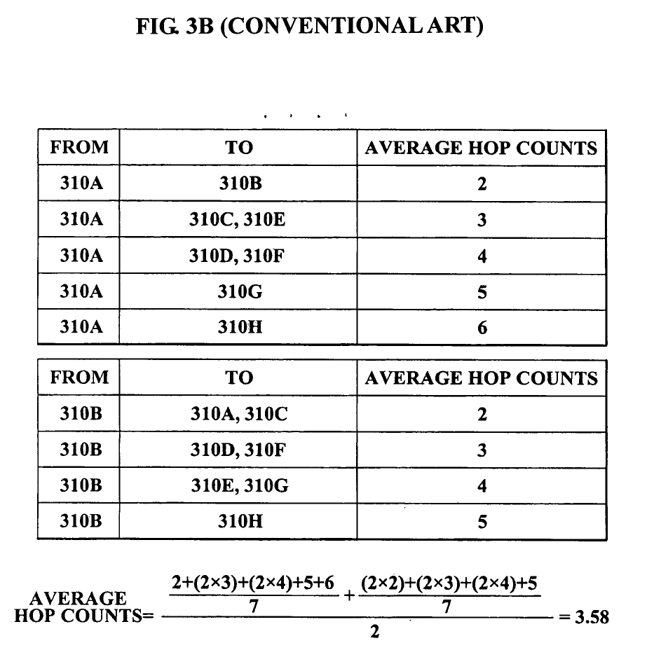

It may be easily seen that the above described average hop count is much smaller than the conventional average hop counts described in FIGS. 1B, 2B, and 3B. Accordingly, according to an exemplary embodiment of the present invention, design of a computer chip capable of operating at high speeds is possible by reducing a number of hops through which data is transferred from one module to another module on a computer chip. This indicates that design of a computer chip operating at high speeds is possible.

Next, to measure an efficiency of channel utilization with respect to the topology of FIG. 9A, an L/U ratio is computed. In FIG. 9A, there are a total of eight IPs. A total number of ports used in connecting the IPs is computed. In FIG. 9A, since the routers 910, 920, 930, and 940 have input/output ports in four directions, there are four input ports and four output ports. Accordingly, a total number of the ports of the routers is computed as “number of routers (4) * number of ports per router (4*2)=32”. Accordingly, the L/U ratio of the topology in FIG. 9A is (4*4*2)/8=4.

It may be seen that the L/U ratio is much lower than the L/U ratio described with reference to FIGS. 1A, 2A, and 3A. Accordingly, according to an exemplary embodiment of the present invention, since modules on a computer chip are disposed at a lower L/U ratio, a number of lines connecting the modules on the computer chip becomes reduced. Accordingly, according to an exemplary embodiment of the present invention, complexity of design of a computer chip and a size of the computer chip becomes reduced. Also, according to this, complexity of wiring on the computer chip also becomes reduced.

In the topology of FIG. 9A, two IPs are connected to one router. If three IPs are connected to one router, a total number of ports of routers is increased by 8 than the topology of FIG. 9A and a number of IPs becomes 12. Therefore, an L/U ratio becomes (32+8)/12=3.33. Namely, according to an exemplary embodiment of the present invention, the more IPs connected to one router, the less connection lines used per IP. Therefore, efficient utilization of space on a computer chip may be higher. According to the present invention, if an IP is bidirectionally connected to one router, more IPs can be connected to the same router. Accordingly, since an exemplary embodiment of the present invention may be applied to a design of a computer chip requiring a large number of IPs, excellent extensibility may be provided.

As described above, an aspect of the present invention provides a computer chip capable of quickly transferring data and operating at high speeds by reducing a number of hops through which the data is transferred from one module to another module on the computer chip.

An aspect of the present invention also provides a computer chip in which modules on the computer chip are disposed with a small L/U ratio to reduce a number of lines connecting the modules on the computer chip, thereby reducing complexity in designing the computer chip and reducing a size of the computer chip.

An aspect of the present invention also provides a method of performing efficient data communication on a star torus topology or star mesh topology on the computer chip provided by the present invention, and a packet format.

An aspect of the present invention also provides a computer chip having high extensibility, in which IPs may be easily added, thereby being applied to designing a computer chip requiring a large number of IPs.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A computer chip comprising:
a plurality of routers, each of the plurality of routers connected to other adjacent routers of the plurality of routers in an X-axis direction and a Y-axis direction; and
a plurality of intellectual properties, wherein each of the plurality of intellectual properties is connected to only one of the plurality of routers, and each of the plurality of routers is connected to at least two of the plurality of intellectual properties.

2. The computer chip of claim 1, wherein each of the plurality of routers is bidirectionally connected to the other adjacent routers in the X-axis direction and the Y-axis direction.

3. The computer chip of claim 1, wherein each of the plurality of routers is connected in a circular topology, with respect to the X-axis direction and the Y-axis direction.

4. The computer chip of claim 3, wherein each of the plurality of routers is connected in a unidirectional circular topology, with respect to the X-axis direction and the Y-axis direction.

5. The computer chip of claim 4, wherein the plurality of routers employ a virtual channel.

6. The computer chip of claim 1, wherein the each of the plurality of routers is connected to the same number of intellectual properties.

7. The computer chip of claim 6, wherein the each of the plurality of intellectual properties is bidirectionally connected to a corresponding router of the plurality of routers.

8. The computer chip of claim 1, wherein the plurality of routers and the plurality of intellectual properties connected to each other are connected via a network interface element, and the network interface element performs protocol conversion between respective routers and respective intellectual properties.

9. The computer chip of claim 1, wherein the plurality of routers route data from a source intellectual property to a destination intellectual property.

10. The computer chip of claim 9, wherein each of the plurality of routers comprises:
a plurality of input and output ports;
an first flow controller which controls a data flow between the router and a router connected to the router in the X-axis direction;
an first arbiter which arbitrates communication between the router and the router connected to the router in the X-axis direction;
a second flow controller which controls a data flow between the router and a router connected to the router in the Y-axis direction;
a second arbiter which arbitrates communication between the router and the router connected to the router in the Y-axis direction;
an intellectual property flow controller which controls a data flow between the router and an intellectual property of the plurality of intellectual properties connected to the router;
an intellectual property arbiter which arbitrates communication between the router and the intellectual property connected to the router; and
a switch which switches the plurality of input and output ports.

11. The computer chip of claim 1, wherein data is transferred between the plurality of routers and the plurality of intellectual properties as a packet which includes a source intellectual property address field, a source router address field, a destination intellectual property address field, and a destination router address field.

12. The computer chip of claim 11, wherein:
a source intellectual property address provided in the source intellectual property address field identifies a source intellectual property among the plurality of intellectual properties; and
a destination intellectual property address provided in to the destination intellectual property address field identifies a destination intellectual property among the plurality of intellectual properties.

13. The computer chip of claim 11, wherein an address of each of the plurality of routers comprises an X axis router address and a Y axis router address and each of the plurality of routers can be uniquely identified on the computer chip by the X axis router address and the Y axis router address.

14. The computer chip of claim 13, wherein the source router address field and the destination router address field comprise an X axis router address field and a Y axis router address field, respectively.

15. A computer chip comprising:
a plurality of routers;
a plurality of communication paths which connect the plurality of routers, wherein the plurality of communication paths is configured in a torus topology; and
a plurality of intellectual properties, wherein each of the plurality of intellectual properties is connected to only one of the plurality of the routers, and each of the plurality of routers is connected to at least two of the plurality of intellectual properties.

16. The computer chip of claim 15, wherein each of the plurality of routers comprises:
a plurality of input and output ports;
an first flow controller which controls a data flow between the router and an router connected to the router in an X-axis direction;
an first arbiter which arbitrates communication between the router and a router connected to the router in the X-axis direction;
a second flow controller which controls a data flow between the router and a router connected to the router in a Y-axis direction; and
a second arbiter which arbitrates communication between the router and a router connected to the router in the Y-axis direction.

17. The computer chip of claim 16, wherein each of the plurality of routers further comprises:
an intellectual property flow controller which controls a data flow between the router and an intellectual property connected to the router;
an intellectual property arbiter which arbitrates communication between the router and an intellectual property connected to the router; and
a switch which switches the plurality of input and output ports.

18. The computer chip of claim 17, wherein each of the plurality of routers is bidirectionally connected to the other adjacent routers in the X-axis direction and the Y-axis direction.

19. The computer chip of claim 17, wherein each of the plurality of routers is connected in a circular topology, with respect to the X-axis direction and the Y-axis direction.

20. The computer chip of claim 19, wherein each of the plurality of routers is connected in a unidirectional circular topology, with respect to the X-axis direction and the Y-axis direction.
